(19) United States
(12) Patent Application Publication
(10) Pub. No.: US 2017/0289358 A1
(43) Pub. Date: Oct. 5, 2017

(54) Device, System, and Process for Wireless Call Hunting

(71) Applicant: TracFone Wireless, Inc., Miami, FL (US)

(72) Inventor: Theodore Vagelos, Miami, FL (US)

(21) Appl. No.: 15/474,201

(22) Filed: Mar. 30, 2017

Related U.S. Application Data
(60) Provisional application No. 62/315,354, filed on Mar. 30, 2016.

(51) Int. Cl. H04M 7/00; H04M 7/12; H04L 29/06

(52) U.S. Cl. CPC H04M 7/006; H04L 65/1006; H04L 65/1023; H04M 7/127

(57) ABSTRACT

A configuration to provide wireless call hunting includes a system configured to receive an incoming call to a wireless number, the system further configured to implement a plurality of lines that are associated with the wireless number, the system further configured to determine if one or more of the plurality of lines of the wireless number are busy, and the system further configured to determine if one or more of the plurality of lines of the wireless number are available. The system further configured to prevent connecting to one or more of the plurality of lines of the wireless number that are busy, and the system further configured to connect to one of the plurality of lines of the wireless number that is not busy, where the system includes one of the following: a soft switch and mobile telephone switching office. A process is disclosed as well.

### CROSS REFERENCE TO PRIOR APPLICATIONS

This application claims the benefit of U.S. Provisional Application No. 62/315,354 filed on Mar. 30, 2016, which is hereby incorporated by reference in its entirety for all purposes as if fully set forth herein.

### BACKGROUND OF THE DISCLOSURE

### 1. Field of the Disclosure

The disclosure relates to a device, system, and process for wireless call hunting implemented in a mobile switching office. The disclosure also relates to a device, system, and process for wireless call hunting implemented in a soft switch.

### 2. Related Art

As more and more businesses are trying to cut the cord and utilize wireless services, they have found that they are unable to move to these wireless services because today's wireless services do not support call hunting. Call hunting is the process where the incoming call “hunts” to find an available line associated with a multiple line system. In this regard, the wireless carriers do not support call hunting. Instead, the wireless carriers provide call forward busy function, which is cost prohibitive. In this regard, the wireless carriers charge on a per-minute basis for every call forwarded busy call in addition to the cost of the wireless call.

Accordingly, a need exists to provide a device, system, and process for wireless call hunting.

### SUMMARY OF THE DISCLOSURE

The foregoing needs are met, to a great extent, by the disclosure, providing a device, system, and method for providing wireless call hunting.

According to some aspects of the disclosure, a configuration to provide wireless call hunting includes a system configured to receive an incoming call to a wireless number, the system further configured to implement a plurality of lines that are associated with the wireless number, the system further configured to determine if one or more of the plurality of lines of the wireless number are busy, the system further configured to determine if one or more of the plurality of lines of the wireless number are available, the system further configured to prevent connecting to one or more of the plurality of lines of the wireless number that are busy, and the system further configured to connect to one of the plurality of lines of the wireless number that is not busy, where the system includes one of the following: a soft switch and mobile telephone switching office.

According to some aspects of the disclosure, a process to provide wireless call hunting includes receiving an incoming call to a wireless number with a system, the system configured to implement a plurality of lines that are associated with the wireless number, determining if one or more of the plurality of lines of the wireless number is busy with the system, determining if one or more of the plurality of lines of the wireless number are available with the system, preventing connection to one or more of the plurality of lines of the wireless number that are busy with the system, and connecting to one of the plurality of lines of the wireless number that is not busy with the system, where the system includes one of the following: a soft switch and mobile telephone switching office.

There has thus been outlined, rather broadly, certain aspect of the disclosure in order that the detailed description thereof herein may be better understood, and in order that the present contribution to the art may be better appreciated. There are, of course, additional aspects of the disclosure that will be described below and which will also form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such those skilled in the art will appreciate that the conception upon which this disclosure is based may readily be utilized as a basis for the designing of other structures, methods and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

The above mentioned features and aspects of the disclosure will become more apparent with reference to the following description taken in conjunction with the accompanying drawings wherein like reference numerals denote like elements and in which:

FIG. 1 illustrates a first aspect of a call hunting process in accordance with aspects of the present disclosure.

FIG. 2 illustrates a second aspect of a call hunting process in accordance with aspects of the present disclosure.

FIG. 3 illustrates a schematic of one aspect of a system for implementing the call hunting process in accordance with aspects of the present disclosure.

FIG. 4 illustrates a schematic of another aspect of a system for implementing the call hunting process in accordance with aspects of the present disclosure.

FIG. 5 illustrates a schematic of an exemplary implementation of a wireless device in accordance with aspects of the present disclosure.

FIG. 6 illustrates a schematic of an exemplary implementation of a wireless device in accordance with aspects of the present disclosure.

FIG. 7 illustrates a schematic of another aspect of a system for implementing the call hunting process in accordance with aspects of the present disclosure.

### DETAILED DESCRIPTION

Reference in this specification to “one aspect,” “an aspect,” “other aspects,” “one or more aspects” or the like means that a particular feature, structure, or characteristic described in connection with the aspect is included in at least one aspect of the disclosure. The appearances of, for example, the phrase “in one aspect” in various places in the specification are not necessarily all referring to the same aspect, nor are separate or alternative aspects mutually exclusive of other aspects. Moreover, various features are described which may be exhibited by some aspects and not by others. Similarly, various requirements are described which may be requirements for some aspects but not for other aspects.

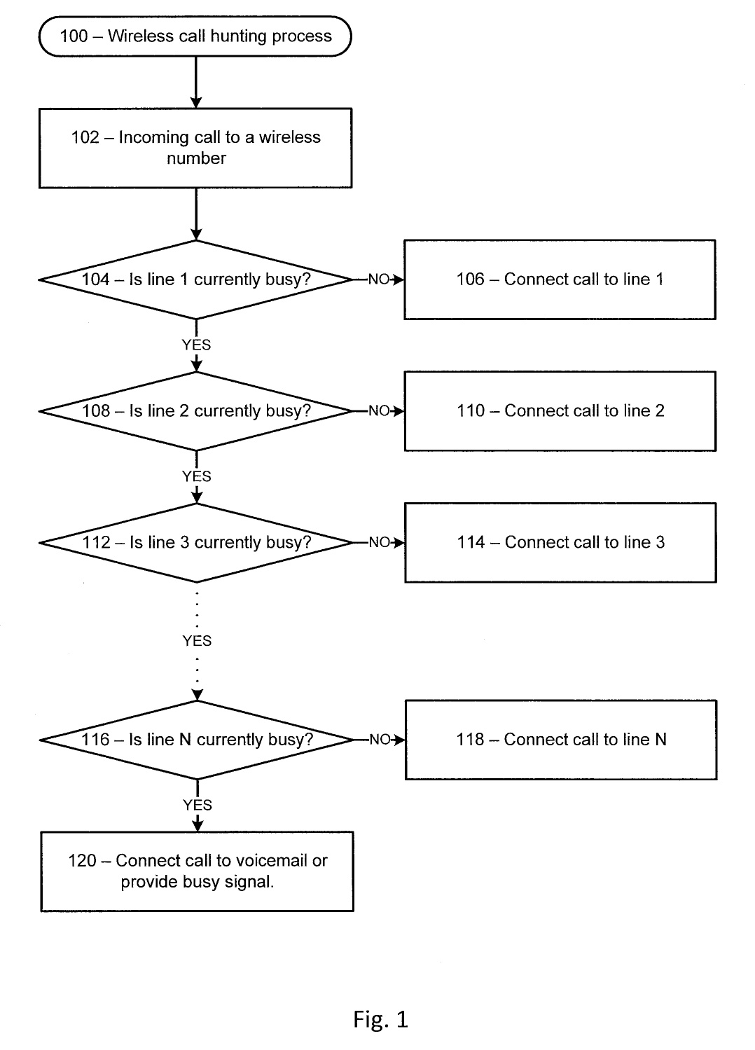

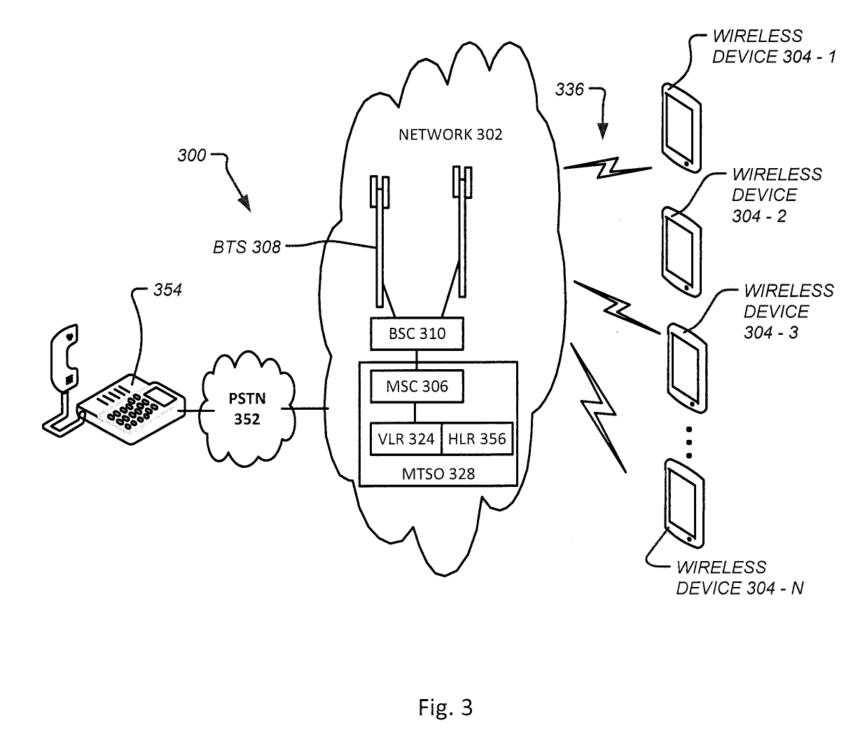

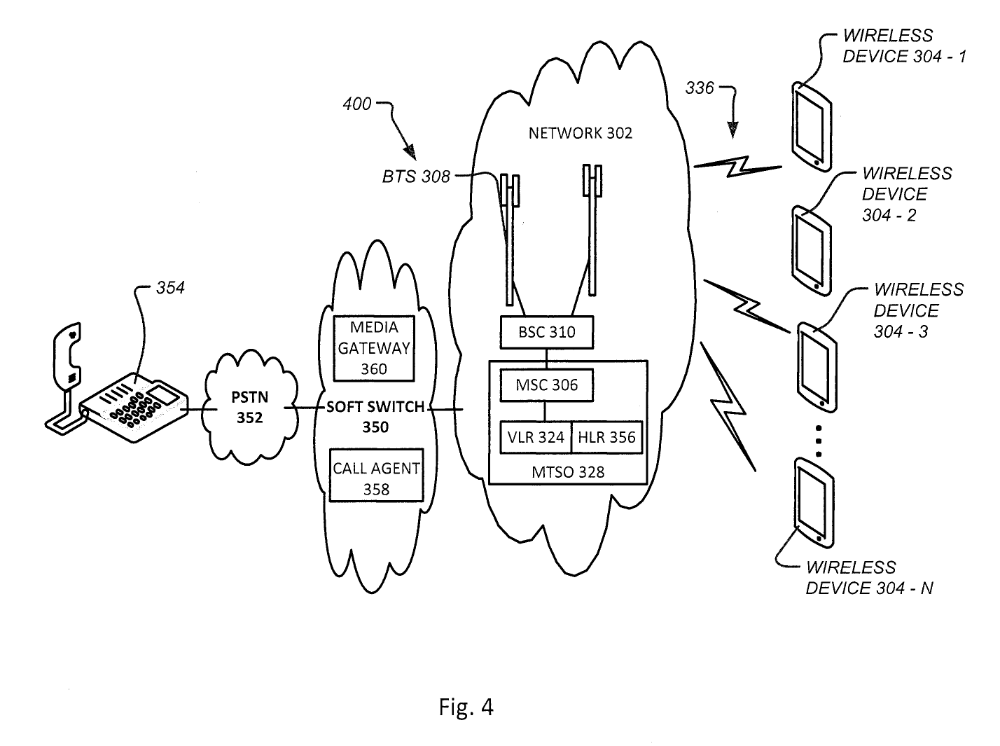

FIG. 1 illustrates a first aspect of a call hunting process in accordance with aspects of the present disclosure. In particular, FIG. 1 illustrates a wireless call hunting process 100 that may be implemented in a system. The system may be a system 300 implemented in a wireless carrier as described in reference to FIG. 3 or the system may be a system 400 implemented at least in part in a soft switch as described with reference to FIG. 4.

As shown in box 102, the system 300, 400 may receive an incoming call to a wireless number. The incoming call may be a local call, a long distance call, or a toll free call. In one aspect, the wireless number is implemented by a wireless network 302 as described in detail with respect to FIG. 3. In one aspect, the wireless number is implemented by a wireless network 302 as described in detail with respect to FIG. 4.

In box 104, the process 100 determines whether line 1 is currently busy. If line 1 is currently busy, the process 100 moves to box 108. If line 1 is not currently busy, the process 100 advances to box 106 and the wireless call is connected to line 1.

In box 108, the process 100 determines whether line 2 is currently busy. If line 2 is currently busy, the process 100 moves to box 112. If line 2 is not currently busy, the process 100 advances to box 110 and the wireless call is connected to line 2.

In box 112, the process 100 determines whether line 3 is currently busy. If line 3 is currently busy, the process 100 moves to box 116. If line 3 is not currently busy, the process 100 advances to box 114 and the wireless call is connected to line 3.

In box 116, the process 100 determines whether line N is currently busy, where N may be any whole number. If line N is currently busy, the process 100 moves to box 120. If line N is not currently busy, the process 100 advances to box 118 and the wireless call is connected to line N. In this regard, the process contemplates having N number of lines as indicated by the dashed line between box 112 and box 116.

In this regard, each of boxes 104, 108, 112, and 116 prevent or avoid an incoming call from connecting to a busy line. In other words, each of boxes 104, 108, 112, and 116 circumvent and/or reroute an incoming call from connecting to a busy line.

In box 120, because each of the wireless lines 1-N were found to be busy, the process 100 may connect the call to a voicemail system. Alternatively, the process 100 may provide a busy signal to the caller.

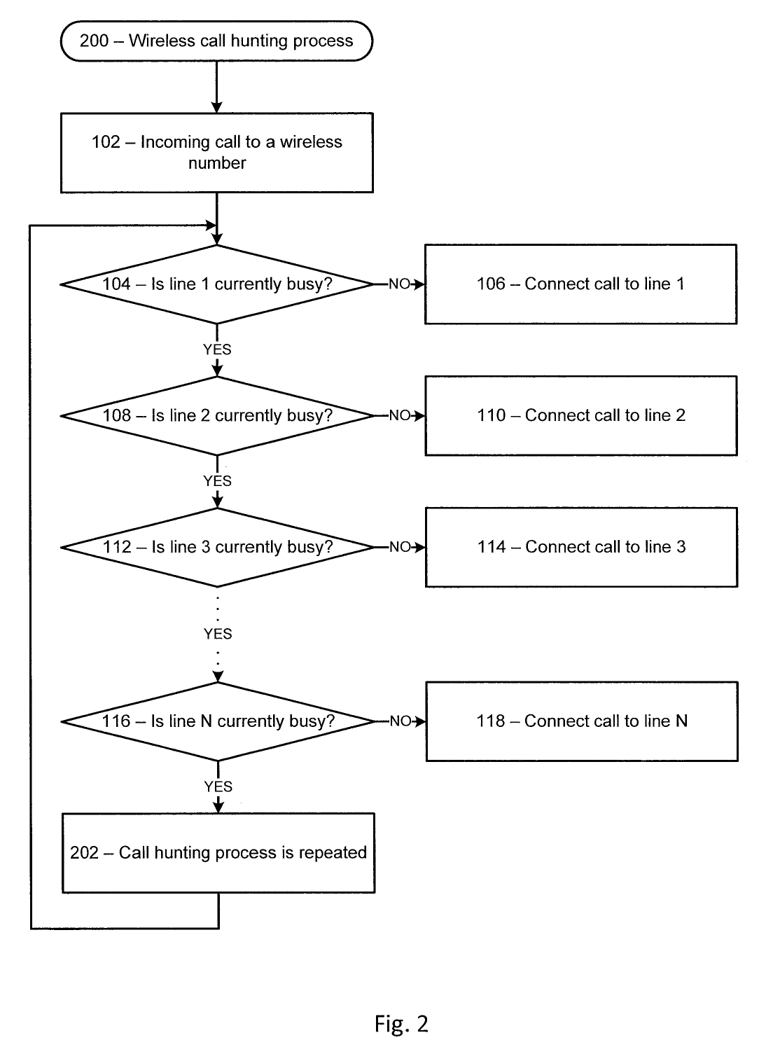

FIG. 2 illustrates a second aspect of the call hunting process in accordance with aspects of the present disclosure. In particular, FIG. 2 illustrates a wireless call hunting process 200 that may be implemented in a system. In one aspect, the system may be a system 300 implemented in a wireless network 302 as described in reference to FIG. 3. In one aspect, the system may be a system 400 implemented at least in part in a soft switch as described with reference to FIG. 4.

As further shown in FIG. 2, each of the boxes 102-118 may provide similar functionality as described above with respect to process 100. Additionally, process 200 shown in FIG. 2 further provides box 202 that repeats the process 200 starting with box 104. The process 200 accordingly provides a “round-robin” distribution of incoming calls to each of the wireless lines associated with the wireless number. The first call is delivered to wireless line 1, the next call goes to wireless line 2, the next call goes to wireless line 3, etc. Accordingly, the process 200 may even out the distribution of incoming calls to each of the wireless lines associated with the wireless number. In one aspect, the wireless lines 1-N are skipped only if they are busy.

In a further aspect of the processes of FIG. 1 and FIG. 2, the order in which each of the wireless lines 1-N are selected may be non-sequential. In one aspect, the order in which you to the wireless lines 1-N are selected may be random. In one aspect, the order in which you to the wireless lines 1-N are selected may be based on an even distribution to ensure that no particular line is implemented more than any other particular line.

FIG. 3 illustrates a schematic of one aspect of a system for implementing the call hunting process in accordance with aspects of the present disclosure. In particular, FIG. 3 shows a wireless network 302. The wireless network 302 may include a base transceiver station 308 (BTS), a base station controller 310 (BSC), a VLR 324 (visitor location register), an HLR 356 (home location register), and a MSC 306 (mobile switching center) overseen by a network operator of the wireless network 302. Other types of wireless networks utilizing a communication channel as defined herein are contemplated as well.

A MTSO 328 (Mobile Telephone Switching Office) may include switching equipment and/or the MSC 306 for routing the wireless calls. The MTSO 328 may also include equipment for controlling cell sites that are connected to the MSC 306.

The MSC 306 may be connected to a close telephone exchange by a trunk group. The trunk group provides an interface to the PSTN 352 (public switch telephone network). The MSC 306 may also provide connectivity to the PSTN 352.

The wireless network 302 may communicate with a wireless device 304 over a communication channel 336 as defined herein. The wireless device 304 may have the wireless number associated with line 1, line 2, line 3, . . . line N. As shown in FIG. 3, the wireless device 304 may be implemented as wireless device 304-1, wireless device 304-2, wireless device 304-3, . . . wireless device 304-N. Where N can be any whole number.

In one aspect, the wireless network 302 may further communicate over the PSTN 352 to a caller utilizing a phone 354. The caller utilizing the phone 354 is the source of the incoming call to the wireless number associated with the wireless device 304 that may have the wireless number associated with line 1, line 2, line 3, . . . line N. As noted above, the wireless device 304 may be implemented as wireless device 304-1, wireless device 304-2, wireless device 304-3, . . . wireless device 304-N.

In one aspect, the wireless network 302 may further communicate to a caller utilizing a phone 354 implemented as a wireless phone communicating over a communication channel as defined herein. The caller utilizing the phone 354 is the source of the incoming call to the wireless number associated with the wireless device 304 that may have the wireless number associated with line 1, line 2, line 3, . . . line N.

In one aspect, the wireless network 302 may further communicate to a caller utilizing a phone 354 implemented as a Voice over Internet Protocol (VoIP) phone communicating over a communication channel as defined herein. The caller utilizing the phone 354 is the source of the incoming call to the wireless number associated with the wireless device 304 that may have the wireless number associated with line 1, line 2, line 3, . . . line N.

In one aspect, the process 100 may be implemented by the wireless network 302. In one aspect, the process 100 may be implemented by the MSC 306. In one aspect, the process 100 may be implemented by the MTSO 328. In one aspect, the process 100 may be implemented by the wireless network 302, the MSC 306, and the MTSO 328. In one aspect, the process 100 may be implemented by the system 300.

In one aspect, the process 200 may be implemented by the wireless network 302. In one aspect, the process 200 may be implemented by the MSC 306. In one aspect, the process 200 may be implemented by the MTSO 328. In one aspect, the process 200 may be implemented by the wireless network 302, the MSC 306, and the MTSO 328. In one aspect, the process 200 may be implemented by the system 300.

FIG. 4 illustrates a schematic of another aspect of a system for implementing the call hunting process in accordance with aspects of the present disclosure. In particular, the wireless network 302 shown in FIG. 4 may include one or more of the same components as the wireless network 302 shown in FIG. 3. The system 400 of FIG. 4 may further include a soft switch 350. The soft switch 350 may be configured to connect telephone calls from one phone line to another, across a telecommunication network or the public Internet. The soft switch 350 may include software running on a general-purpose computer system, a non-generic computer system, a server, a telecommunications computer, a telecommunications server, an Internet protocol telecommunications computer, an Internet protocol telecommunications server, or the like.

The soft switch 350 may be used to control connections at a junction point between circuit-switched and packet-switched networks. In one aspect, the soft switch 350 may be used to control connections at a junction point between the PSTN 352 and the wireless network 302. The soft switch 350 may contain both a switching logic and a switched fabric that may be used for this purpose. The soft switch 350 may further include a call agent 358 and/or a media gateway 360.

In one aspect, the soft switch 350 may front end the MTSO 328 to implement the process 100 and/or implement the process 200. The soft switch 350 may anchor the calls. In one aspect, deactivation of call waiting may be needed. Once a wireless line is available, the soft switch 350 may send the call to the MTSO 328 via Session Initiation Protocol (SIP), Time-division multiplexing (TDM), or the like.

In one aspect, the SIP may be implemented independent from an underlying transport protocol. The SIP may operate on the Transmission Control Protocol (TCP), the User Datagram Protocol (UDP), the Stream Control Transmission Protocol (SCTP) or the like. In one aspect, the TDM may be implemented by transmitting and receiving independent signals over a common signal path by means of synchronized switches at each end of the transmission line so that each signal appears on the line only a fraction of time in an alternating pattern. The SIP may include a SIP request and/or SIP response. The SIP request may be based on RFC 3261 and may include the following functionality implemented by the soft switch 350 or similar system: REGISTER: Used by a UA to register to the registrar, INVITE: Used to establish a media session between user agents, ACK: Confirms reliable message exchanges, CANCEL: Terminates a pending request, BYE: Terminates an existing session, OPTIONS: Requests information about the capabilities of a caller without the need to set up a session, REFER: indicates that the recipient should contact a third party using the contact information provided in the request (call transfer), and the like. The SIP response may be based on RFC 3261 and may include the following functionality implemented by the soft switch 350 or similar system: Provisional: Request received and being processed, Success: The action was successfully received, understood, and accepted, Redirection: Further action needs to be taken (typically by sender) to complete the request, Client Error: The request contains bad syntax or cannot be fulfilled at the server, Server Error: The server failed to fulfill an apparently valid request, Global Failure: The request cannot be fulfilled at any server, and the like.

The call agent 358 may take care of functions such as billing, call routing, signaling, call services and the like, supplying the functional logic to accomplish these telephony meta-tasks. The call agent 358 may control several different media gateways in geographically dispersed areas via a TCP/IP link. The call agent 358 may also be used to control the functions of the media gateway 360, in order to connect with media as well as other interfaces.

The media gateway 360 may connect different types of digital media stream together to create an end-to-end path for the media (voice and data) in the call. It may have interfaces to connect to the PSTN 352, such as DS1 ports, DS3 ports and/or the like. The call agent 358 may instruct the media gateway 360 to connect media streams between these interfaces to connect the call. The soft switch 350 may include SS7 cards, SIGTRAN cards, or the like. The soft switch 350 may include software in terms of signaling and trunking gateway for voice traffic IP/TDM, TDM/IP, TDM/TDM functions. The soft switch 350 may be implemented as a class 4 soft switch, class 5 soft switch and/or the like.

In one aspect, the process 100 may be implemented by the soft switch 350. In one aspect, the process 100 may be implemented by the call agent 358. In one aspect, the process 100 may be implemented by the media gateway 360. In one aspect, the process 100 may be implemented by the soft switch 350, the call agent 358, and the media gateway 360. In one aspect, the process 100 may be implemented by the system 400.

In one aspect, the process 200 may be implemented by the soft switch 350. In one aspect, the process 200 may be implemented by the call agent 358. In one aspect, the process 200 may be implemented by the media gateway 360. In one aspect, the process 200 may be implemented by the soft switch 350, the call agent 358, and the media gateway 360. In one aspect, the process 200 may be implemented by the system 400.

In a further aspect of the soft switch 350, the soft switch 350 may be configured as an Automatic Call Distributor (ACD) front end. More specifically, the soft switch 350 may receive the incoming call to the wireless number. If each of the plurality of wireless lines 1-N of the wireless number are busy (“yes” to each of boxes 104, 108, 112, 116), the soft switch 350 configured with and/or as the ACD may place the incoming call in a queue. The queue may hold the incoming call until one of the plurality of wireless lines 1-N of the wireless number are no longer busy and thereafter connect the queued incoming call to the now available one of the plurality of wireless lines 1-N of the wireless number. In one aspect, the queue of the ACD may operate in a First In First Out basis (FIFO). In a further aspect, the ACD may be configured to provide an even distribution among each the plurality of wireless lines 1-N of the wireless number. In a further aspect, the ACD may be configured to provide a priority queue that may connect an incoming phone call prior to connecting other incoming phone calls based on predetermined priority.

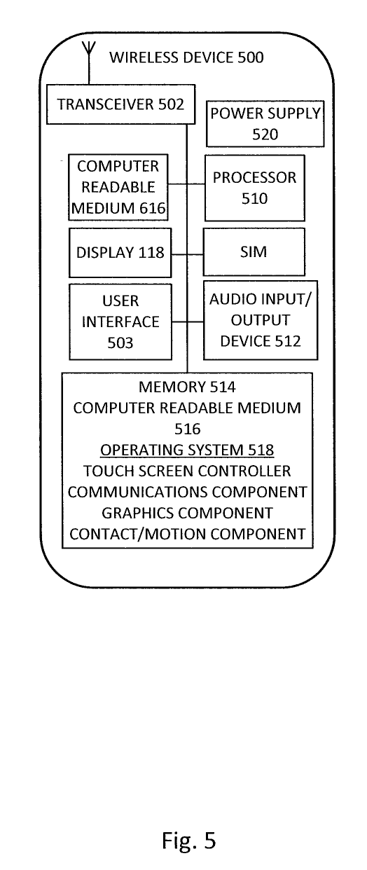

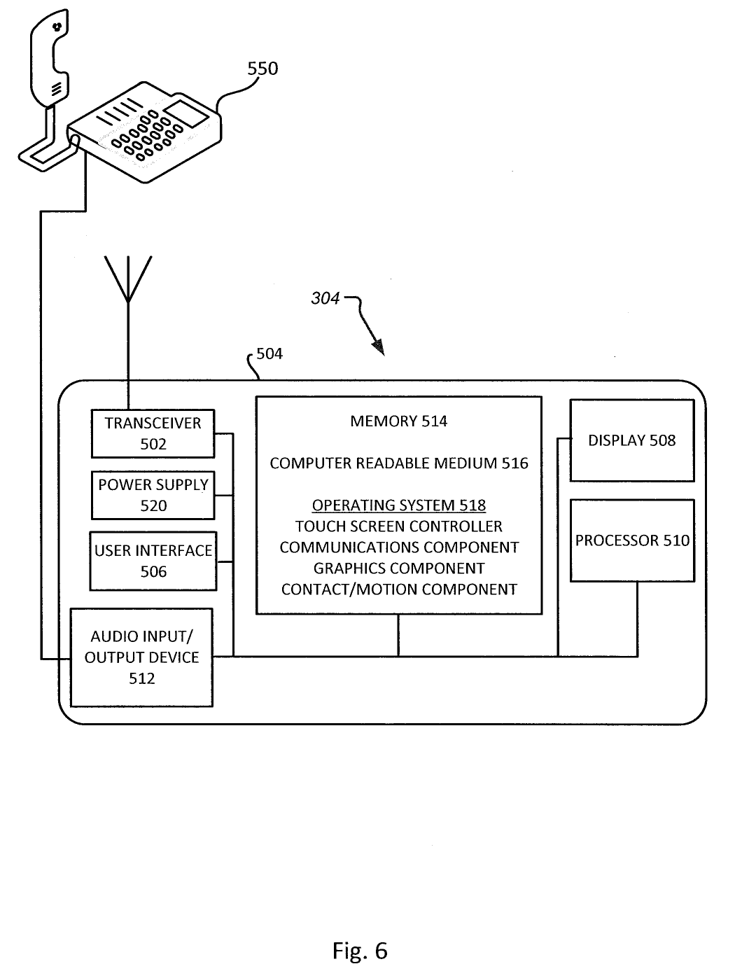

FIG. 5 illustrates a schematic of a wireless device in accordance with aspects of the present disclosure. In particular, FIG. 5 illustrates an exemplary wireless device 304 operating as a wireless device 500 according to the disclosure. The wireless device 500 may include a transceiver 502, a power supply 520, a user interface 506, a display 508, a processor 510, an audio input/output device 512, a memory 514, a computer readable medium 516, an operating system 518, and the like. The transceiver 502 can include, for example, a wireless antenna and associated circuitry capable of data transmission with the wireless network 302 utilizing at least one data transmission protocol, such as, for example, 3G, 4G, 5G (5th generation mobile networks/wireless systems), Long Term Evolution (LTE), Evolution-Data Optimized (EVDO), Code Division Multiple Access (CDMA), High Speed Packet Access (HSPA), Global System for Mobile Communications (GSM), W-CDMA (Wideband Code-Division Multiple Access), Wi-Fi, Bluetooth, a communication channel as defined herein, and/or the like, and/or combinations thereof. The transceiver 502 may transmit and receive data using the data transmission protocol in order to provide telephone service to the wireless device 500. The wireless device 500 may further include additional features consistent with the description of FIG. 6.

FIG. 6 illustrates a schematic of a wireless device in accordance with aspects of the present disclosure. In particular, FIG. 6 illustrates an exemplary wireless device 304 operating as a wireless telephone base station 504 according to the disclosure. The wireless telephone base station 504 may include a transceiver 502, a power supply 520, a user interface 506, a display 508, a processor 510, an audio input/output device 512, a memory 514, a computer readable medium 516, an operating system 518, and the like. The transceiver 502 can include, for example, a wireless antenna and associated circuitry capable of data transmission with the wireless network 302 utilizing at least one data transmission protocol, such as, for example, 3G, 4G, 5G (5th generation mobile networks/wireless systems), Long Term Evolution (LTE), Evolution-Data Optimized (EVDO), Code Division Multiple Access (CDMA), High Speed Packet Access (HSPA), Global System for Mobile Communications (GSM), W-CDMA (Wideband Code-Division Multiple Access), Wi-Fi, Bluetooth, a communication channel as defined herein, and/or the like, and/or combinations thereof. The transceiver 502 may transmit and receive data using the data transmission protocol in order to provide telephone service to a connected telephone 550.

The power supply 520 may be a battery such as nickel cadmium, nickel metal hydride, lead acid, lithium ion, lithium ion polymer, and the like. The power supply 520 may be charged by and/or receive power from a power receptacle or another external power source such as a nominal 120 V household power supply. The power supply 520 may be implemented without a battery and utilize an external power source such as a nominal 120 V household power supply.

In one aspect of the present disclosure, the user interface 506 may accept user inputs and provide outputs via the display 508. The display 508 of the wireless telephone base station 504 can show various information provided from the power supply 520, the processor 510, the memory 514, the computer readable medium 516, or the like. The display 508 may have a screen which may be a light-emitting diode display (LED), an electroluminescent display (ELD), a plasma display panel (PDP), a liquid crystal display (LCD), an organic light-emitting diode display (OLED), or any other display technology.

The displayed information can include, for example, the network connection strength, the type of mobile network data connection (such as 3G, 4G, 5G, LTE, EVDO, etc.) to which the wireless telephone base station 504 is connected, battery life, the power supply 520 strength, and/or other information potentially useful to the user. If the display 508 is a touch-screen, the user may interact with icons on the display 508 to select the various types of information available for display.

The processor 510 can be, for example, dedicated hardware as defined herein, a computing device as defined herein, a microprocessor, a computer processor, a processor, a programmable logic array (PLA), a programmable array logic (PAL), a generic array logic (GAL), a complex programmable logic device (CPLD), an application-specific integrated circuit (ASIC), a field-programmable gate array (FPGA), a processor, a microprocessor or any other programmable logic device (PLD).

Additionally, the wireless telephone base station 504 may include the audio input/output device 512 for the input or output of sounds, and the like. For example, the audio input/output device 512 may a speaker output device and the like. The audio input/output device 512 may further include a connection to connect to the telephone 550 via an RJ-45 cable or the like to provide telephone service to the telephone 550, and to provide audio or visual outputs, including the wireless emergency alerts, to the telephone 550.

For example, the wireless telephone base station 504 may connect the telephone 550 to wireless network 302. The wireless telephone base station 504 may further generate a dial tone, provide access to voice mail, and generate audio for a telephone call that may be received by the wireless telephone base station 504 and may accordingly be passed from the wireless telephone base station 504 to the telephone 550 in accordance with the process 100 and/or the process 200.

The wireless telephone base station 504 may also include a memory 514, which may be an internal memory or a removable storage type such as a memory chip. The memory 514 may store information about the wireless telephone base station 504, including wireless profiles and settings. The memory 514 may further include a SIM or UICC card type memory to enable communication with a wireless network requiring the same.

For the purposes of this disclosure, the computer readable medium 516 may store computer data, which may include computer program code that may be executable by the processor 510 in machine readable form. By way of example, and not limitation, the computer readable medium 516 may include computer readable storage media, for example tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules, or other data.

The user interface 506 may facilitate use of the wireless telephone base station 504 with an operating system 518. The operating system 518 may be associated with a touchscreen controller, one or more communications components, one or more graphics components, one or more contact/motion components, and the like.

The wireless telephone base station 504 may also be used in conjunction with a telephone 550. The wireless telephone base station 504 may physically or wirelessly connect to the telephone 550. The telephone 550 may be part of a phone system when coupled with the wireless telephone base station 504. The telephone 550 may have a transceiver, a power supply, a keyboard, a user interface, a display, a processor, an audio input/output device, a memory, a computer readable medium, an operating system, a handset, and the like.

Alternatively, the telephone 550 may be a more simplistic implementation that may include a speaker, a microphone, a hook switch, a touchtone keypad and frequency generator, a duplex coil, and a ringer speaker all connected by a common wire pair.

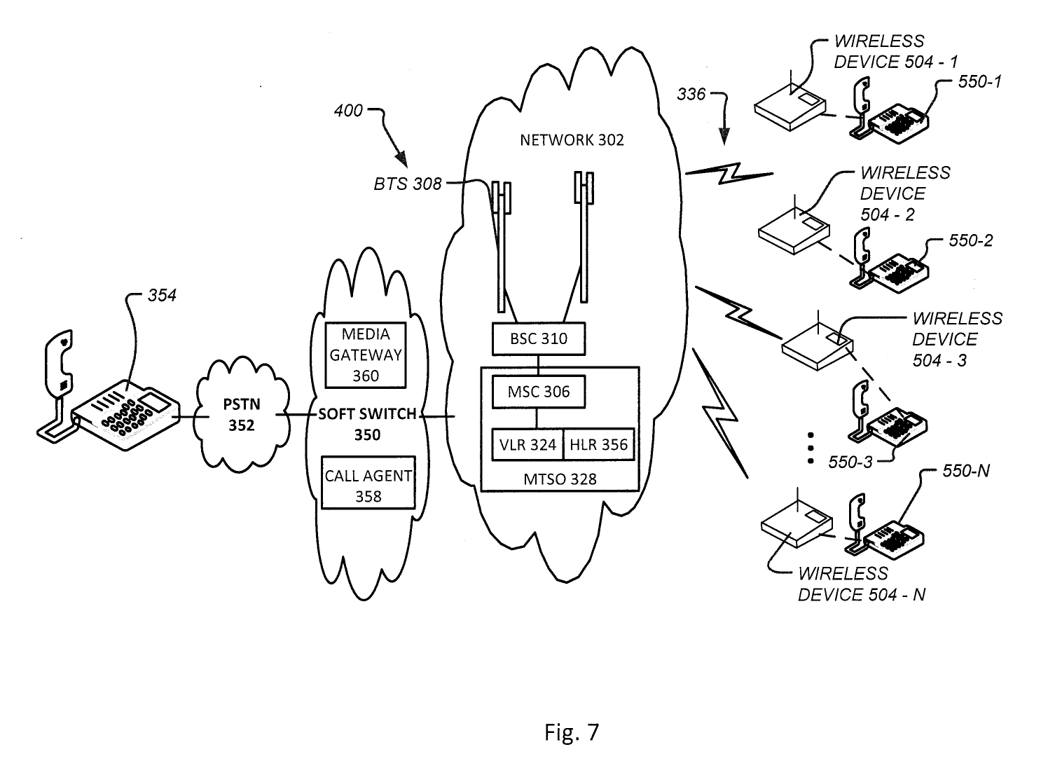

FIG. 7 illustrates a schematic of another aspect of a system for implementing the call hunting process in accordance with aspects of the present disclosure. In particular, FIG. 7 may include one or more of the features shown in FIG. 4. Additionally, FIG. 7 shows the wireless devices 304 implemented as wireless telephone base stations 504 (504-1-504-N) each connected to a telephone 550 (550-1-550-N). Accordingly, the FIG. 7 implementation provides a business with a solution that may provide wireless call hunting consistent with the disclosure.

Accordingly, as described above the disclosure provides a device, system, and process for wireless call hunting. The device, system, and process for wireless call hunting of the disclosure allows businesses to cut the cord and utilize wireless services. This allows businesses to avoid the wireless carriers call forward busy function, which is cost prohibitive. In this regard, the wireless carriers charge on a per-minute basis for every call forwarded busy call in addition to the cost of the wireless call. For example, with a three-line configuration using call forward busy, carriers would typically charge 167% more “cellular minutes” than for a call hunting scenario of the disclosure.

Further in accordance with various aspects of the disclosure, the methods described herein are intended for operation with dedicated hardware implementations including, but not limited to PCs, PDAs, SIM cards, semiconductors, application specific integrated circuits (ASIC), programmable logic arrays, cloud computing devices, and other hardware devices constructed to implement the methods described herein.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Aspects of the disclosure may include a server executing an instance of an application or software configured to accept requests from a client and giving responses accordingly. The server may run on any computer including dedicated computers. The computer may include at least one processing element, typically a central processing unit (CPU), and some form of memory. The processing element may carry out arithmetic and logic operations, and a sequencing and control unit may change the order of operations in response to stored information. The server may include peripheral devices that may allow information to be retrieved from an external source, and the result of operations saved and retrieved. The server may operate within a client-server architecture. The server may perform some tasks on behalf of clients. The clients may connect to the server through the network on a communication channel as defined herein. The server may use memory with error detection and correction, redundant disks, redundant power supplies and so on.

The disclosure may include communication channels 336 that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, 4G (fourth generation mobile telecommunications technology), Long Term Evolution (LTE), 5G (5th generation mobile networks or 5th generation wireless systems), EVolution-Data Optimized (EVDO) and/or the like, and/or a combination of two or more thereof.

The disclosure may be implemented in any type of computing devices or processor, such as, e.g., a desktop computer, personal computer, a laptop/mobile computer, a personal data assistant (PDA), a mobile phone, a tablet computer, cloud computing device, and the like, with wired/wireless communications capabilities via the communication channels 336.

In an aspect, the disclosure may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

While the device, system, and method have been described in terms of what are presently considered to be specific aspects, the disclosure need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

1. A configuration to provide wireless call hunting, the configuration comprising:
a system configured to receive an incoming call to a wireless number;
the system further configured to implement a plurality of lines that are associated with the wireless number;
the system further configured to determine if one or more of the plurality of lines of the wireless number are busy;
the system further configured to determine if one or more of the plurality of lines of the wireless number are available;
the system further configured to prevent connecting to one or more of the plurality of lines of the wireless number that are busy; and
the system further configured to connect to one of the plurality of lines of the wireless number that is not busy,
wherein the system comprises one of the following: a soft switch and mobile telephone switching office.

2. The configuration according to claim 1 wherein the incoming call originates from one of the following: a call placed on a public switch telephone network, a call placed over a wireless network, and a call placed over a Voice over Internet Protocol network.

3. The configuration according to claim 1 wherein each of the plurality of lines of the wireless number is associated with one of a plurality wireless devices.

4. The configuration according to claim 3 wherein at least one of the plurality wireless devices comprises a wireless base station configured with a telephone.

5. The configuration according to claim 1 wherein the system is further configured, if all of the plurality of lines of the wireless number are busy, to thereafter again determine if one or more of the plurality of lines of the wireless number are busy, prevent connecting to one or more of the plurality of lines of the wireless number that are busy, and connect to one of the plurality of lines of the wireless number that is not busy.

6. The configuration according to claim 1 wherein the system is further configured, if all of the plurality of lines of the wireless number are busy, to thereafter implement at least one of the following: provide a busy signal to the incoming call, place the incoming call into a queue for subsequent connection, and connect the incoming call to a voicemail system.

7. The configuration according to claim 1 wherein the system comprises the soft switch and the soft switch is configured to anchor the incoming call to the wireless number that includes the plurality of lines.

8. The configuration according to claim 1 wherein the system comprises the soft switch and the soft switch is configured send a SIP message to connect the incoming call to one of the plurality of lines of the wireless number that is not busy.

9. The configuration according to claim 8 wherein the soft switch further comprises a call agent and a media gateway.

10. The configuration according to claim 1 wherein the system comprises the mobile telephone switching office and the mobile telephone switching office is configured to anchor the incoming call to the wireless number that includes the plurality of lines.

11. A process to provide wireless call hunting, the process comprising:
receiving an incoming call to a wireless number with a system, the system configured to implement a plurality of lines that are associated with the wireless number;
determining if one or more of the plurality of lines of the wireless number is busy with the system;
determining if one or more of the plurality of lines of the wireless number are available with the system;
preventing connection to one or more of the plurality of lines of the wireless number that are busy with the system; and
connecting to one of the plurality of lines of the wireless number that is not busy with the system,
wherein the system comprises one of the following: a soft switch and mobile telephone switching office.

12. The process according to claim 11 wherein the incoming call originates from one of the following: a call placed on a public switch telephone network, a call placed over a wireless network, and a call placed over a Voice over Internet Protocol network.

13. The process is according to claim 11 wherein each of the plurality of lines of the wireless number is associated with one of a plurality wireless devices.

14. The process according to claim 13 wherein at least one of the plurality wireless devices comprises a wireless base station configured with a telephone.

15. The process according to claim 11 further comprising determining if all of the plurality of lines of the wireless number are busy, to thereafter again determine if one or more of the plurality of lines of the wireless number are busy, prevent connecting to one or more of the plurality of lines of the wireless number that are busy, and connect to one of the plurality of lines of the wireless number that is not busy.

16. The process according to claim 11 further comprising implementing, if all of the plurality of lines of the wireless number are busy, at least one of the following: provide a busy signal to the incoming call, place the incoming call into a queue for subsequent connection, and connect the incoming call to a voicemail system.

17. The process according to claim 11 wherein the system comprises the soft switch and the soft switch is configured to anchor the incoming call to the wireless number that includes the plurality of lines.

18. The process according to claim 11 wherein the system comprises the soft switch and the soft switch is configured send a SIP message to connect the incoming call to one of the plurality of lines of the wireless number that is not busy.

19. The process according to claim 18 wherein the soft switch further comprises a call agent and a media gateway.

20. The process according to claim 11 wherein the system comprises the mobile telephone switching office and the mobile telephone switching office is configured to anchor the incoming call to the wireless number that includes the plurality of lines.
